(19) United States
(12) Patent Application Publication
(10) Pub. No.: US 2013/0220155 A1
(43) Pub. Date: Aug. 29, 2013

(54) SINGLE DRIVE SYSTEM FOR CONTROLLING MULTIPLE INDEPENDENT GRIPPER SHAFTS

(71) Applicants: Konstantin Kupershtoch, Rehovot (IL); Isaac Naor, Hod-Hasharon (IL); Ofer Ben Bassat, Ramat-Gan (IL)

(72) Inventors: Konstantin Kupershtoch, Rehovot (IL); Isaac Naor, Hod-Hasharon (IL); Ofer Ben Bassat, Ramat-Gan (IL)

(21) Appl. No.: 13/534,876

(22) Filed: Jun. 27, 2012

Related U.S. Application Data
(63) Continuation-in-part of application No. 13/407,269, filed on Feb. 28, 2012.

(51) Int. Cl. B41F 21/10

(52) U.S. Cl. 101/409; 101/483

(57) ABSTRACT

An independently driven symmetric cam individually opens and closes two different gripper shafts attached to an impression surface to grip and release leading edges of two different media sheets. Also disclosed is a single drive system for controlling multiple independent gripper shafts includes an impression cylinder, at least two gripper shafts on the impression surface of the impression cylinder to hold at least two media sheets to the impression surface, a dynamic cam to independently actuate each of the at least two gripper shafts, and a single drive motor to mechanically rotate the dynamic cam with respect to the impression surface.

The present application is a continuation-in-part, and claims the benefit under 35 U.S.C. §120, of U.S. application Ser. No. 13/407,269, entitled “Cam Positioned to Retract a Mechanical Component” to Ofer Ben Bassat, et al., filed Feb. 28, 2012. This application is hereby incorporated by reference in its entirety.

### BACKGROUND

Printers can use rotating drums to control print media and ink deposition during a printing process. In some implementations, print media is secured to the outer surface of an impression cylinder during deposition of ink images. The impression cylinder rotates during printing to present the appropriate portion of the print media for the deposition of the ink images. After the desired ink images are deposited on the print media, the print media is released from the impression cylinder and the impression cylinder secures the next sheet of print media to its surface.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a printer that includes an impression cylinder assembly, according to one example of principles described herein.

FIG. 2 is a side view of an impression cylinder assembly that includes a single driving system for controlling multiple independent gripper shafts, according to one example of principles described herein.

FIG. 3 is a cross sectional view of a dynamic cam and cam follower mechanisms for a single driving system for controlling multiple independent gripper shafts, according to one example of principles described herein.

FIG. 4 is a perspective view of an impression cylinder with a single driving system for controlling multiple independent gripper shafts, according to one example of principles described herein.

FIG. 5 is a flowchart of a method for using an impression cylinder with a single driving system for managing print media during printing, according to one example of principles described herein.

FIG. 6 is a flow chart of a method for selectively closing and opening gripper sets to selectively grip and release print media, according to one example of principles described herein.

Throughout the drawings, identical reference numbers designate similar, but not necessarily identical, elements.

### DETAILED DESCRIPTION

During the operation of a digital printing system, ink images are formed on the surface of a photo-imaging cylinder. These ink images are transferred to a heated blanket cylinder and then to an impression cylinder. The impression cylinder holds a print medium, such as a sheet of paper, on its surface to receive the ink images. The impression cylinder receives print media from a feeding mechanism and secures the print media throughout the ink deposition process. When the image on the print medium is completed, the impression cylinder releases the print medium and secures another sheet for printing. The press control cylinder includes a number of mechanisms to control the position, timing, and sequential transfer of print media on the impression cylinder.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

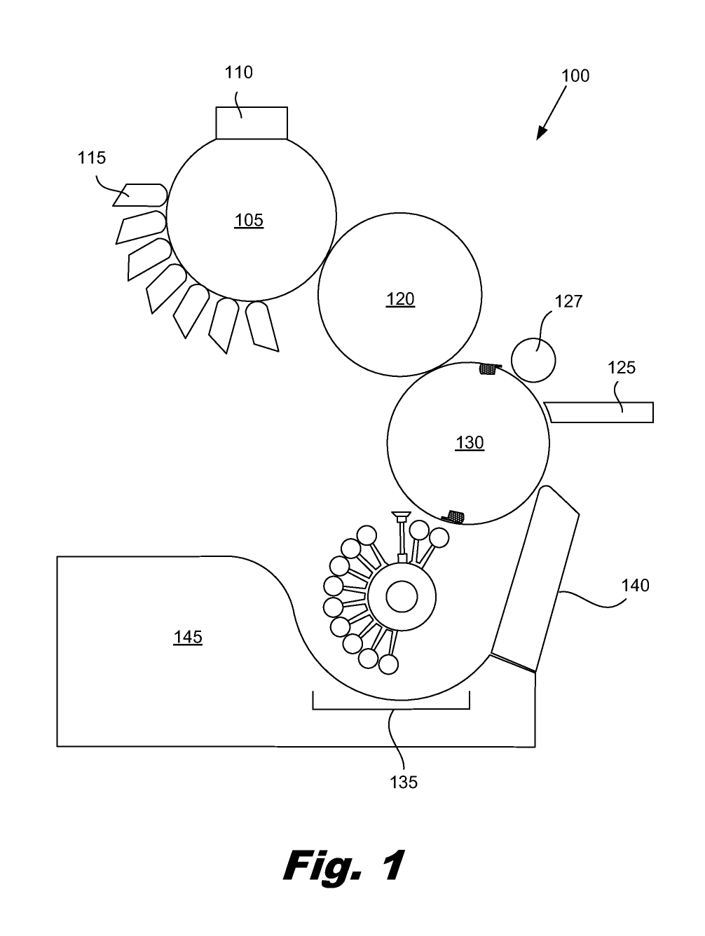

FIG. 1 is a diagram of one illustrative example of a printing system that includes an impression cylinder. The desired image is initially formed on the photo-imaging cylinder (105). The desired image may be text, pictures, black/white images, partial color, full color images, or any combination of text and images. According to one example, the photo-charging/laser imaging unit (110) charges portions of the photo-imaging cylinder (105) that correspond to a first color of ink that makes the desired image. A first binary ink developer (115) presents a uniform surface of ink to the photo imaging cylinder (105). The charged portions of the photo-imaging cylinder (105) attract the ink and form the desired ink pattern on the photo-imaging cylinder (105). This ink pattern is transferred to the blanket cylinder (120).

The sheet of print media enters the printing system (100) from the right, passes over the feed tray (125), and is wrapped onto the impression cylinder assembly (130). The impression cylinder assembly (130) can secure the sheet to its surface in a number of ways, including pulling the sheet against the surface using a vacuum, electrostatic adhesion, and mechanical clamping. In one example, the impression cylinder of the impression cylinder assembly secures the leading edge of the sheet using grippers. The impression cylinder rotates on an axis to present the appropriate portion of the media to the blanket cylinder (120). The blanket cylinder (120) transfers the ink pattern to the sheet as the sheet passes between the blanket cylinder (120) and the impression cylinder (130). To form a single color image (such as a black and white image), one rotation of the sheet with the impression cylinder completes the desired image. For a multiple color image, the sheet is retained on the impression cylinder and makes multiple contacts with the blanket cylinder (120). At each contact, an additional color is placed on the sheet of print media. For example, to generate a four-color image, the photo-charging unit (110) forms a second pattern on the photo-imaging cylinder (105) that receives the second ink color from a second binary ink developer. As described above, this second ink pattern is transferred to the blanket cylinder (120) and impressed onto the sheet as it continues to rotate with the impression cylinder. This continues until the desired image is formed on the sheet of print media. In other embodiments, multiple colors may be deposited simultaneously.

After the desired image is formed on a single sided print, the impression cylinder assembly (130) passes the printed sheet to the perfector (135) that moves the sheet to the exit guide (145). For double-sided prints, the perfector (135) and duplex conveyor (140) perform the more complex task of reversing the sheet and reintroducing the sheet to the impression cylinder assembly so that the blank surface of the sheet is on the outside of the impression cylinder assembly (130) to receive the second image.

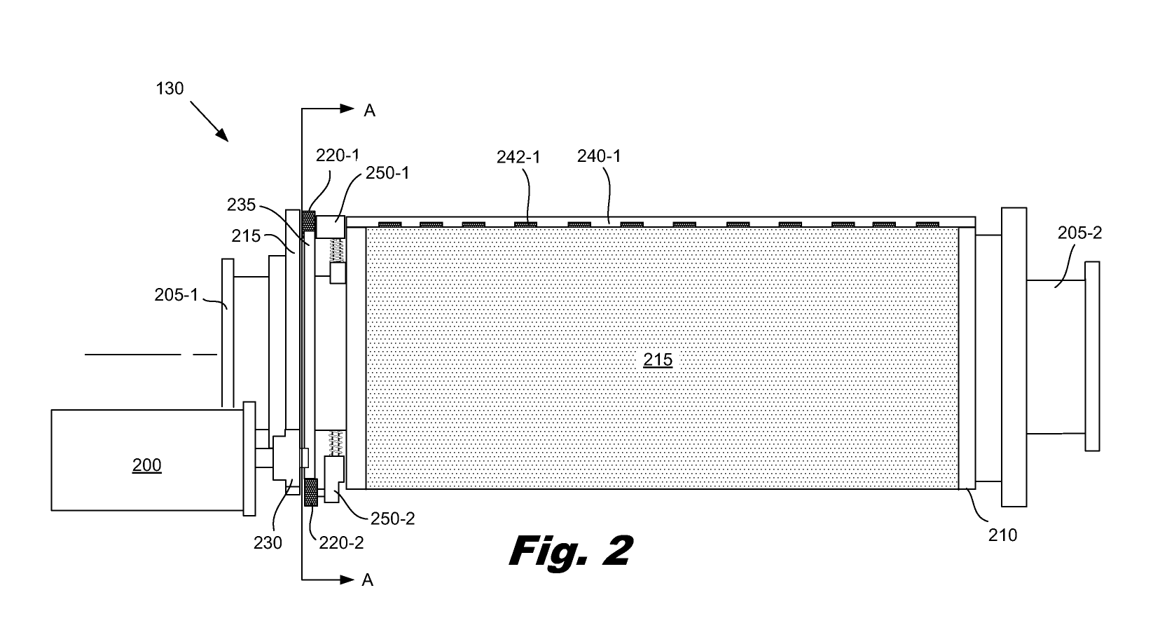

FIG. 2 is a side view of an impression cylinder assembly (130) that includes a single driving system for controlling two independent gripper shafts (240). The impression cylinder assembly (130) includes an impression cylinder (210) that is supported by bearing housings (205); these bearing housings are mounted to? the press walls. The impression cylinder (210) is operated by a main drive, which is not shown. The main drive (210) may be used to synchronously drive a number of components, including the photo imaging cylinder (105, FIG. 1) and blanket cylinder (120, FIG. 1).

In this example, the impression cylinder assembly (130) is in place to secure two media sheets at once to the impression cylinder (210). However, the principles discussed herein could be applied to an impression cylinder assembly that secures 2, 3, 4 or more media sheets to the impression cylinder at one time. In this example, the impression cylinder (210) includes two independent gripper shafts (240) that manipulate a set number of grippers (242). The gripper shafts (240) rotate a first direction to lift the grippers (242) above the cylindrical surface of impression cylinder (210) and rotate an opposite direction to clamp the grippers (242) against the cylindrical surface of the impression cylinder (210). In FIG. 2, the grippers (242) grasp the leading edge of the media sheet (215) to secure it to the impression cylinder (210).

The single drive system for controlling the two shafts includes a drive motor (200), a motor gear (230), and a driven gear (215). The driven gear (215) is connected to a dynamic cam (235). The dynamic cam (235) and driven gear (215) are driven about a central axis by the drive motor (200). The angular position of the dynamic cam (235) and driven gear (215) is mechanically independent of the angular position of the impression cylinder (210).

Two cam followers (220) are connected to the impression cylinder and roll over the cam (235) and control the rotation of the gripper shafts (240) and the grippers (242) connected to the shafts. By selectively rotating the cam (235) with respect to the impression drum, the cam followers (220) are lifted/dropped to close/open the grippers (242), thereby securing/releasing the leading edge of the media sheet (215).

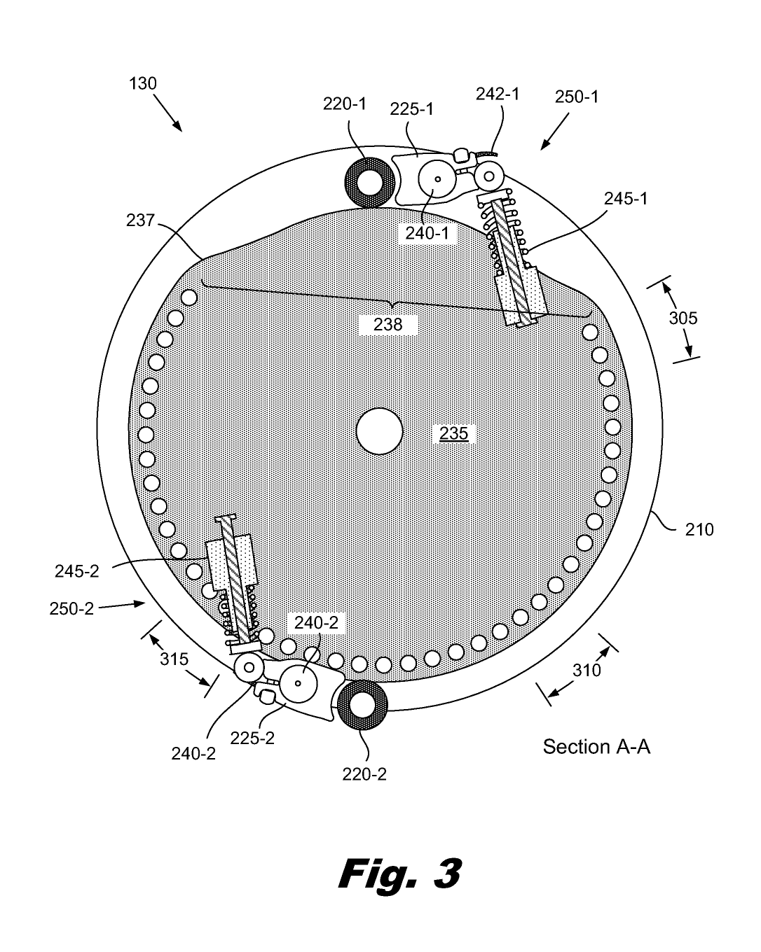

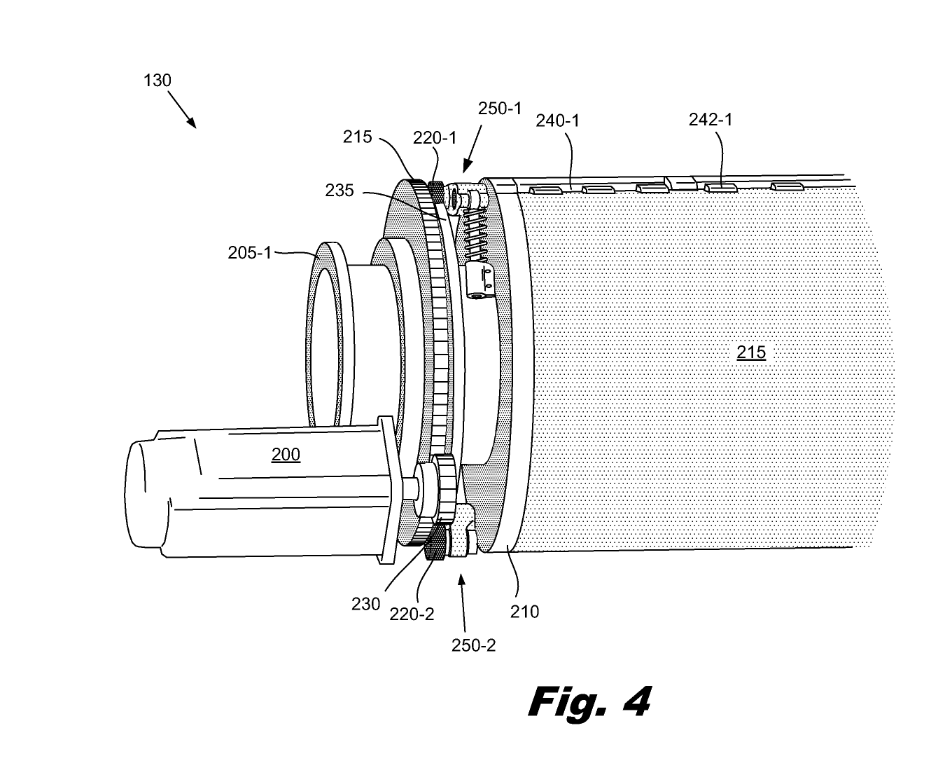

FIG. 3 is a cross sectional view of a cam and cam follower mechanisms for a single driving system for controlling two independent gripper shafts taken along line A-A in FIG. 2. From a strictly mechanical perspective, portions of the cam follower mechanisms (250), including the spring mechanisms (252) would be behind the cam (235) and obscured from view. However, for purposes of illustration, all of the cam follower mechanisms have been shown in FIG. 3.

FIG. 3 shows more detail about the operation of the dynamic cam (235), cam follower mechanisms (250) and the rotation of the shafts (240) and grippers (242). The two-gripper shafts (240) are located on opposite sides of the impression cylinder. As shown in FIG. 2, each shaft (240) extends along the length of the impression drum and actuates a set of grippers (242). One end of the shaft is clamped in the follower body (225). The follower body connects the shaft to the cam follower (220) and the spring mechanisms (245). The spring mechanisms (245) provide a biasing force that presses the cam followers (220) against the cam surface profile (237). This ensures that the cam followers (220) are in contact with the cam surface profile. In this example, the cam surface profile (237) is primarily circular with an indented portion (238) that allows the cam follower (220) to drop a predetermined distance toward the center of the cam (235). In the example shown in FIG. 3, a first cam follower (220-1) is positioned over the indented portion (238). The spring force generated by the spring mechanism (245-1) presses on the cam body (225-1) and forces the cam follower (220-1) the indented portion (238). As the cam follower (220-1) drops into the intended portion (238), the cam follower assembly (250-1) rotates and opens the grippers (242-1) along the length of the gripper shaft (240-1). This releases a media sheet from the surface of the impression drum (210) and allows another sheet to be inserted. The dynamic cam (235) is then rotated with respect to the impression cylinder (210) to force the cam follower (220-1) upward and close the grippers to grasp the leading edge of the media sheet.

The second cam mechanism (250-2) is shown with the cam follower (220-2) riding on the circular portion of the cam surface profile (237). The cam (220-2) is more radially distant from the center of the cam (235) and rotates the shaft (240-2) so that grippers (242-2) closed. The grippers (242-2) in their closed position do not extend substantially above the surface of the impression drum (210) and are mostly hidden behind a portion of the cam follower mechanism (250-2) in this view.

As can be seen in FIG. 3, in this implementation there is only one indented portion (238) in the cam (235). Consequently, only one set of grippers are allowed to be opened at a time. FIG. 3 shows three separate activation regions (305, 310, and 315). The loading region (305) represents an angular position of the impression drum (210) where the grippers need to be open to receive a new sheet of media from the feed tray (125, FIG. 1). The duplex region (310) represents the region where the grippers need to be open to receive a sheet that has been reversed by the perfector (135) and duplex conveyor (140) so that it can be printed on the opposite side. The exit region (315) represents the region where grippers need to open to allow the perfector to remove a sheet from the impression drum. The location and size of these regions is only illustrative. The regions could have different sizes and locations, subject to the constraints described below. Because the example drive system can only open one of the gripper sets at a time, the actuation regions (305, 310, 315) should not be placed so that both gripper sets need to be open at the same time. Consequently, in this two sheet system, if the regions are not located directly opposite each other (180 degrees apart), there will not be a specific instant that both grippers need to be open at the same time. Similarly, the regions can be located around the impression cylinder assembly to avoid the need to simultaneously open gripper sets in systems that have 3, 4, or more sheets on an impression cylinder at the same time. However, this operational constraint is not absolute. A system that does not meet this operational constraint can still be operated by opening one of the gripper sets to allow entry/exit of a leading edge of a media substrate while the other sheet of media continues to be gripped for another revolution of the impression drum. This reduces the throughput of the system, but allows the system to continue to operate.

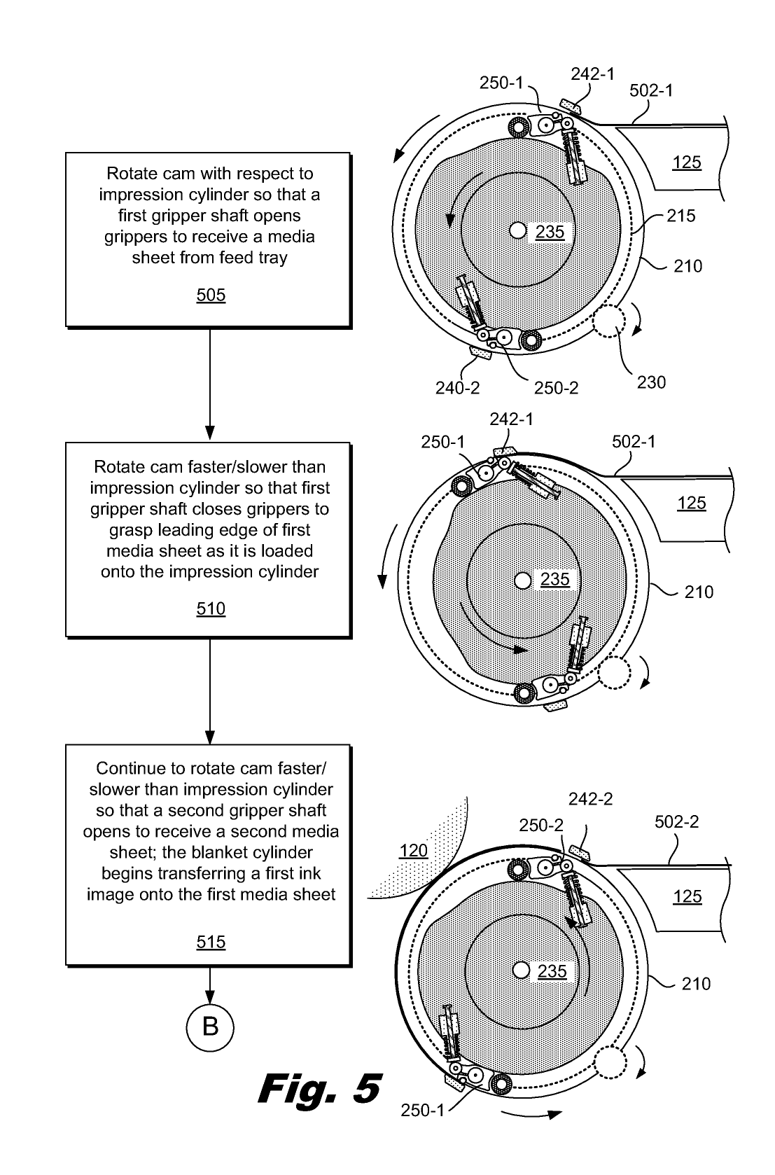

FIG. 4 is a perspective view of an impression cylinder assembly (130) with a single driving system (200, 230, 215) for controlling multiple independent gripper shafts (240). As discussed above, the impression cylinder assembly (130) includes an impression surface (210) and gripper shafts (240) on the impression cylinder (210) to hold at least two media sheets to the impression surface. An independently driven symmetric cam (235) individually opens and closes the two different gripper shafts (240) attached to the impression cylinder (210) to grip and release leading edges of two different media sheets. The dynamic cam (235) independently actuates each of the gripper shafts (240). In some implementations, the gripper shafts (240) are spaced 180 degrees apart on the impression surface. The single drive motor (200) mechanically rotates the dynamic cam (235) with respect to the impression surface (210). The gripper shafts (240) include a plurality of grippers (“a gripper set”) that grips a leading edge of a media sheet placed underneath them. A cam follower assembly (250) includes a cam follower (220) that travels over a profile surface of the dynamic cam (235) and is connected to the gripper shafts (240).

In some implementations, the profile surface of the dynamic cam (235) is symmetric and activates only one of the two-gripper shafts at a time. In other embodiments, the cam may not be symmetric and different drive profiles can be used for each rotational direction. Entry and exit regions of the media sheets onto/off of the impression cylinder (210) are arranged in such a way that the multiple media sheets do not enter or exit the impression cylinder (210) simultaneously. This allows the dynamic cam (235) to sequentially activate the gripper shafts (240) one at a time to accomplish the desired media motion. The dynamic cam (235) rotates about to be on the same axis as the impression cylinder (210). In some examples, the rotational axis of the impression cylinder (210) is offset slightly to accommodate thicker print media, while the dynamic cam (235) continues to rotate around the bearing housing that is fixed to wall of the print housing. However, this slight offset of the impression cylinder (210) does not adversely affect the operation of the dynamic cam (235) and activation of the grippers (242).

As discussed above, a main drive mechanism drives the impression cylinder, blanket cylinder, and image cylinder at a near constant velocity during printing. The single drive motor (200) can rotate the dynamic cam (235) at the same speed as the impression cylinder (210) if no change in the position of the grippers (242) is desired or in a posigrade (faster than the impression cylinder) or retrograde (slower than the impression cylinder) relative to the impression cylinder (210) to change the position of the grippers (242).

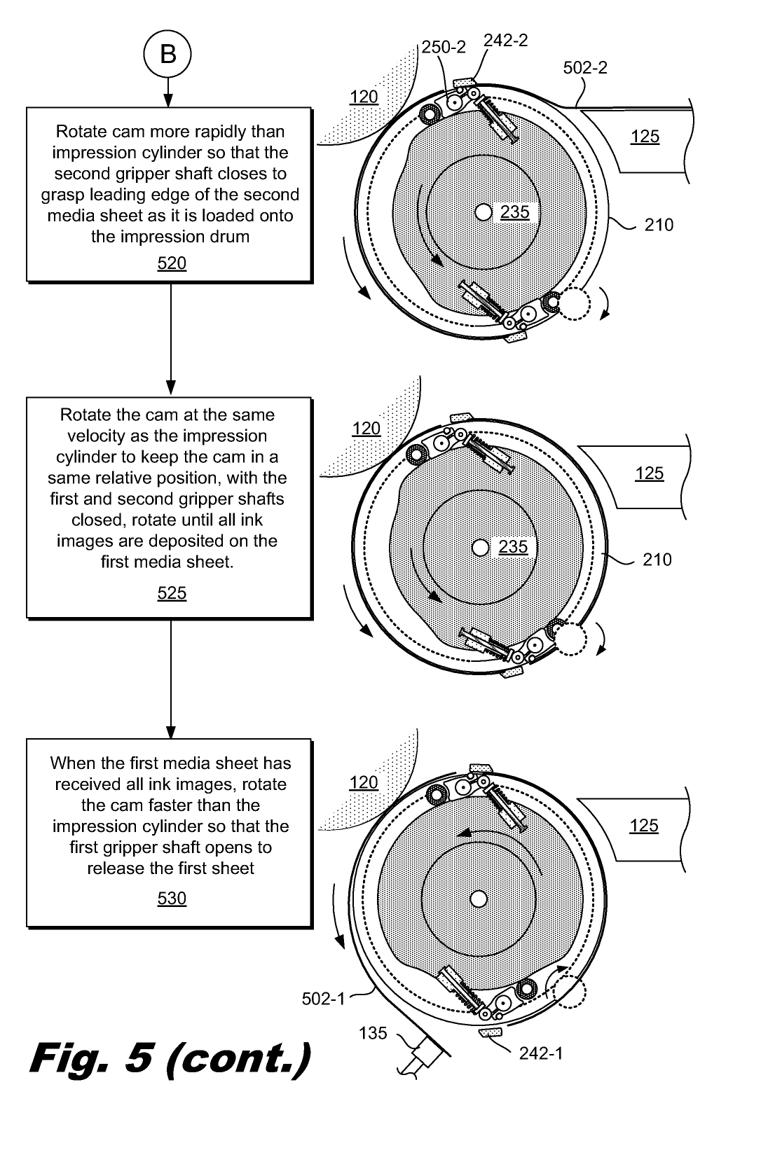

FIG. 5 is a flowchart of a method for using an impression cylinder with a single driving system for managing print media during printing. FIG. 5 shows a number of steps used to load two sheets of print media onto an impression drum, print the desired images onto the sheets and then remove the sheet from the impression drum. In the first block, the cam is rotated with respect to the impression cylinder so that a first gripper shaft opens grippers to receive a media sheet from a feed tray (block 505). To do this, the drive motor (230) engages the driven gear (215) and rotates the attached dynamic cam (235) faster or slower than the impression cylinder (210). In this example, the dynamic cam (235) is rotated faster than the impression cylinder (210). The impression cylinder (210) is typically driven at a constant speed by a main drive. The main drive also rotates the blanket cylinder and imaging cylinder in synchronization with the impression cylinder. By driving the dynamic cam at speeds that are faster or slower than the impression cylinder, the rotational position of the cam relative to the impression cylinder changes. In the examples shown in FIG. 5, the cam is rotated faster than the impression drum to change the relative position of the dynamic cam with respect to the impression drum. This changes the position of the cam follower mechanism (250-1) to rotate the gripper shaft and to open the gripper (242-1). In the series of drawings that accompany the flowchart, the gripper has been enlarged and positioned above the impression cylinder surface so that its motion can be more clearly illustrated.

The impression cylinder (210) continues to rotate. The dynamic cam is rotated at a differential speed so that the first gripper shaft closes the set of grippers to grasp the leading edge of the media as it is loaded onto the impression cylinder (210) (block 510). In this example, the cam (235) is illustrated as rotating faster than the impression cylinder (210). This moves the cam so that the cam follower is pushed radially outward and rotates cam assembly (250-1) and gripper shaft. This rotation of the gripper shaft closes the gripper (242-1) and pinches the leading edge of the first media sheet between the gripper and the impression cylinder (210).

As the impression cylinder (210) rotates at a constant speed, the dynamic cam continues to rotate faster than the impression cylinder so that the second gripper shaft opens the second set of grippers to receive a second media sheet (502-2). Simultaneously, the blanket cylinder (120) begins transferring a first ink image onto the first media sheet as it passes through the pinch point between the impression cylinder (210) and the blanket cylinder (120) (block 515). Due to the cam profile, actuating one of the gripper shafts can't affect/open the second gripper shaft.

The dynamic cam (235) continues to be driven at a differential speed with respect to the impression cylinder (210) so that the second gripper shaft (240-2) closes a second set of grippers (242-2) to grasp the leading edge of the second media sheet as it is loaded onto the impression cylinder (210) (block 520). The two sheets (502-1, 502-2) are now loaded onto the impression cylinder and the trailing portion of the first sheet is receiving the last of the first ink image from the blanket cylinder (120).

At this condition, the positions of both cam followers are known by the control system. The control system is ready to rotate the cam to operate the grippers as needed by the printing sequence. The dynamic cam (235) is rotated at the same velocity as the impression cylinder (210) to keep the cam the same position relative to the impression cylinder. This ensures that the first and second gripper shafts are closed and secures the leading edges of the two media sheets (502) to the impression cylinder (210). The impression cylinder and cam continue to rotate until all the ink images are deposited on the first media sheet (block 525). For example, if a four-color image is being created on the first and second media sheets, the impression cylinder will rotate so that the first media sheet passes through pinch point between the blanket cylinder and the impression cylinder four times. Each time the first media sheet passes through the pinch point, the blanket cylinder deposits one of the four ink images on the media sheet. The retention of each sheet on the impression drum is independent from the other sheet. For example, a four color image could be printed on the first sheet while four one color images are sequentially printed.

When the first media sheet has received all the desired ink images, the cam is rotated at a differential speed with respect to the impression cylinder so that the first gripper shaft opens to release the leading edge of the first sheet (block 530). The perfector (135) or other mechanism removes the first sheet after the grippers (242-1) have released it. The second sheet continues to rotate with the impression cylinder and passes through the pinch point to receive any additional ink images. The first media sheet (502-1) may be replaced by performing blocks 505 and 510. When printing on the second media sheet (502-2) is complete it can be removed in a similar manner to the first media sheet. In general, the retention a sheet on the impression drum is independent of any other sheet. Each sheet can be removed after it has been printed.

In some situations, the media sheets may be reversed and fed back onto the impression cylinder for duplex printing. In other scenarios, only one side of the media is printed and the sheets are passed over an exit guide to a drying station, collator, or catch tray.

The motion of the cam with respect to the impression cylinder may be calculated in real time or may be predetermined for each scenario. The motion of the cam may be determined to optimize a number of parameters, including minimizing energy consumed by the cam drive motor, the maximum speed allowed by the motor performance, reducing acceleration and deceleration values, reducing motor heating, reducing load on the gear system, or other parameters. The opening and closing of the grippers can occur at fixed positions relative to the feed tray, blanket cylinder, or perfector. However, due to the dynamic nature of the mechanism this is not a requirement. The location at which the grippers open and close can be adjusted by altering the motion profile of the dynamic cam.

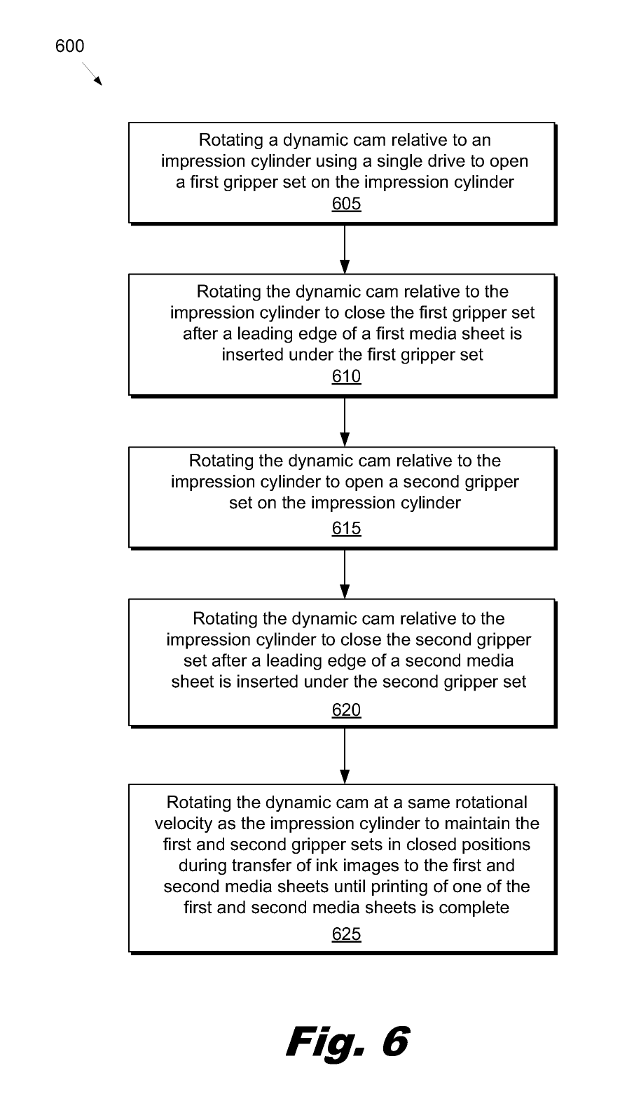

FIG. 6 is a flow chart of a method for selectively closing and opening gripper sets to selectively grip and release print media. A dynamic cam is rotated relative to an impression cylinder using a single drive to open a first gripper shaft on the impression cylinder (block 605). Rotating the dynamic cam relative to the impression cylinder can be performed by speeding or slowing the rotation of the cam with respect to the impression cylinder such that the cam is positioned to release or grip the first media sheet at a predetermined time and angle.

The dynamic cam is rotated relative to the impression cylinder to close the first gripper set after a leading edge of a first media sheet is inserted under the first gripper set (block 610). The dynamic cam is rotated relative to the impression cylinder to open a second gripper set on the impression cylinder (block 615). The dynamic cam is rotated relative to the impression cylinder to close the second gripper set after a leading edge of a second media sheet is inserted under the second gripper set (block 620). The dynamic cam is rotated at the same rotational velocity as the impression cylinder to maintain the first and second gripper set in closed positions during transfer of ink images to the first and second media sheets until printing of one of the first and second media sheets is complete (block 625). The method may also include rotating the dynamic cam relative to the impression cylinder to release one of the first and second media sheets when the printing of that sheet is complete. The motion profile of the cam can be generated to move the cam relative to the impression cylinder to selectively actuate one of a plurality of gripper sets on the impression cylinder. The cam motion profile may be generated to accommodate a print mode to sequentially open and close the gripper sets one at a time, and to minimize energy consumed in moving the dynamic cam.

There are several advantages to using an impression cylinder that holds multiple sheets of media. Because their impression cylinder is bigger, its angular rotation may be slower and the curvature of the individual sheets may be less. This may allow for a wider variety of media to be printed. For example, stiffer media may benefit from the lower amount of curvature of each sheet. Additionally, the slower angular velocities and bigger cylinder diameters provide each sheet with a longer drying time between successive depositions of ink images. This can produce higher quality images and allow for more flexibility in formulating inks. Another advantage is that the printed sheet may be released from the drum after its trailing edge is fully printed and has passed under the blanket cylinder. This can significantly reduce registration errors.

The principles described above provide for a single drive that independently actuates multiple gripper sets. These multiple gripper sets allow multiple media sheets to be attached to the impression cylinder. The drive system controls the cam via a gear transmission. The drive system dynamically controls the cam using programmed motion profiles. The motion profiles may be programmed according to the printing mode and other press control sequences. Activation angles of the gripper shafts may be located at various locations to load and unload media sheets. In some implementations, the activation regions are spaced so that multiple gripper sets do not need to be simultaneously activated. In order to allow activation of the gripper shafts in both directions, the cam may have a symmetric profile. This also simplifies the control formula. In some implementations, using a calibration procedure to precisely locate the cam's axis of symmetry relative to a drive motor encoder may accurately control the gripper shaft motion. To sense the cam location with respect to the main encoder of the press, a proximity sensor may be used to sense the rotating cam. For example, the proximity sensor may be a mechanical or magnetic “home” trigger. Another option is to use drive motor current tracking to control the actual cam position.

By using a single drive to manipulate multiple gripper sets, the cost and complexity of the impression cylinder can be reduced without interfering with the operation of the press. Further, the overall size of the impression cylinder assembly can be reduced because there is only one drive system instead of an individual drive system for each gripper set.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A single drive system for controlling multiple independent gripper shafts comprising:
an impression cylinder;
at least two gripper shafts on an impression surface of the impression cylinder to hold at least two media sheets to the impression surface;
a dynamic cam to independently actuate each of the at least two gripper shafts; and
a single drive motor to mechanically rotate the dynamic cam with respect to the impression cylinder.

2. The system of claim 1, in which each of the gripper shafts comprises a plurality of grippers to grip the leading edge of a media sheet.

3. The system of claim 1, in which the cam follower travels over a profile surface of the dynamic cam and is connected to the gripper shafts.

4. The system of claim 3, in which the profile surface of the dynamic cam is symmetric.

5. The system of claim 1, in which the dynamic cam activates only one of the at least two gripper shafts at a time.

6. The system of claim 1, in which entry regions of media sheets onto the impression surface and an exit region of the media sheets off of the impression surface are arranged such that multiple media sheets do not enter or exit impression surface simultaneously.

7. The system of claim 1, in which dynamic cam rotates about substantially the same axis as the impression cylinder.

8. The system of claim 1, further comprising a main drive to drive the impression surface, a blanket cylinder, and an image cylinder at a constant velocity during printing, in which the imaging cylinder is to generate ink images and the blanket cylinder is to transfer ink images from the imaging cylinder to the media sheets held on the impression surface.

9. The system of claim 1, in which the single drive motor is to rotate the dynamic cam in retrograde with respect to the impression surface to actuate a gripper shaft.

10. The system of claim 1, in which the at least two gripper shafts comprise a first gripper shaft and a second gripper shaft spaced 180 degrees apart on the impression surface.

11. An independently driven symmetric cam to individually open and close two different gripper shafts attached to an impression surface to grip and release leading edges of two different media sheets.

12. A method for printing comprising:
rotating a dynamic cam relative to an impression cylinder using a single drive to open a first gripper set on the impression cylinder;
rotating the dynamic cam relative to the impression cylinder to close the first gripper set after a leading edge of a first media sheet is inserted under the first gripper set;
rotating the dynamic cam relative to the impression cylinder to open a second gripper set on the impression cylinder;
rotating the dynamic cam relative to the impression cylinder to close the second gripper set after a leading edge of a second media sheet is inserted under the second gripper set;
rotating the dynamic cam at a same rotational velocity as the impression cylinder to maintain the first and second gripper set in closed positions during transfer of ink images to the first and second media sheets until printing of one of the first and second media sheets is complete.

13. The method of claim 12, further comprising rotating the dynamic cam relative to the impression cylinder to release one of the first and second media sheets when printing of that sheet is complete.

14. The method of claim 12, further comprising generating a cam motion profile to move the cam relative to the impression cylinder to selectively actuate a plurality of gripper sets on the impression cylinder, in which the cam motion profile is generated to accommodate a print mode, to sequentially open and close each gripper set one at a time, and to minimize energy consumed in moving the dynamic cam.

15. The method of claim 12, in which rotating the dynamic cam relative to the impression cylinder comprises speeding or slowing the rotation of the dynamic cam with respect to the impression cylinder such that the dynamic cam is positioned to release or grip the first media sheet at a predetermined time and angle.
